(19) United States
(12) Patent Application Publication
(10) Pub. No.: US 2012/0214124 A1
(43) Pub. Date: Aug. 23, 2012

(54) High Volume Carpule System

(75) Inventors: Bryan W. McLelland, Liberty Lake, WA (US); Randall T. Palmer, Woodinville, WA (US)

(73) Assignee: Dr. Bryan W. McLelland

(21) Appl. No.: 13/031,455

(22) Filed: Feb. 21, 2011

(51) Int. Cl. A61C 19/08

(52) U.S. Cl. 433/90

(57) ABSTRACT

A high volume carpule system for storing and dispensing a high volume of anesthetic to a patient. A preferred embodiment of the high volume carpule system generally includes a syringe having a modified carpule cavity comprised of an upper ring member and a lower ring member which are linked together by a first side member and a second side member. The side members are oriented in such a manner as to allow a pair of slots through which side portions of a high capacity carpule may extend. A high capacity carpule comprised of a substantially cylindrical shape with an elongated cross-section is disclosed for use with the modified carpule cavity. In an alternate embodiment, a second high capacity carpule design is disclosed for use with conventional, prior art syringes. By using the present invention, a dentist or surgeon may administer a higher volume of anesthetic without having to switch carpules within a syringe.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to a new and improved carpule design and more specifically it relates to a high volume carpule system for storing and dispensing a high volume of anesthetic to a patient.

2. Description of the Related Art

Any discussion of the related art throughout the specification should in no way be considered as an admission that such related art is widely known or forms part of common general knowledge in the field.

Carpules have been in use for years for procedures requiring the application of anesthetic or other compositions with a syringe. Previously existing and widely available carpules for use by dentists or oral surgeons have conventionally been available in certain sizes to fit the conventional, prior art design for syringes designed to carry such carpules. Currently commercially available carpule designs are generally limited to 1.7-1.8 milliliters by volume. Such existing designs are typically limited so that they fit within a mouth and are not too long and unwieldy. Further, existing designs are generally limited to a purely cylindrical shape due to the difficulty in sealing complex geometries due to the high pressure that may be applied to the stopper.

Due to the limited storage capacity of existing carpule designs, a dentist or oral surgeon is often required to change out carpules up to 10-12 times during a routine procedure to ensure effectiveness of the delivered anesthetic for the full course of treatment. Further, the odd size of commercially available carpules (i.e. lidocaine carpules) complicates the delivery of anesthetic due to the calculations that must be performed by a dentist, oral surgeon or their staff to determine the proper amount of anesthetic to deliver to the patient via the syringe.

Because of the inherent problems with the related art, there is a need for a new and improved high volume carpule system for storing and dispensing a high volume of anesthetic to a patient.

### BRIEF SUMMARY OF THE INVENTION

A system for storing and dispensing a high volume of anesthetic to a patient. The invention generally relates to a high volume carpule system. A preferred embodiment of the high volume carpule system generally includes a syringe having a modified carpule cavity comprised of an upper ring member and a lower ring member which are linked together by a first side member and a second side member. The side members are oriented in such a manner as to allow a pair of slots through which side portions of a high capacity carpule may extend. A high capacity carpule comprised of a substantially cylindrical shape with an elongated cross-section is disclosed for use with the modified carpule cavity. In an alternate embodiment, a second high capacity carpule design is disclosed for use with conventional, prior art syringes. By using the present invention, a dentist or surgeon may administer a higher volume of anesthetic without having to switch carpules within a syringe.

There has thus been outlined, rather broadly, some of the features of the invention in order that the detailed description thereof may be better understood, and in order that the present contribution to the art may be better appreciated. There are additional features of the invention that will be described hereinafter and that will form the subject matter of the claims appended hereto. In this respect, before explaining at least one embodiment of the invention in detail, it is to be understood that the invention is not limited in its application to the details of construction or to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is an upper perspective view of a preferred embodiment of the present invention.

FIG. 2 is an upper perspective view of a preferred embodiment of the present invention.

FIG. 3 is a side view of a preferred embodiment of the present invention.

FIG. 4 is a sectional view of a preferred embodiment of the present invention.

FIG. 5 is an upper perspective view of an alternate embodiment of the present invention.

FIG. 6 is an upper perspective view of an alternate embodiment of the present invention.

FIG. 7 is a side view of an alternate embodiment of the present invention.

FIG. 8 is a sectional view of an alternate embodiment of the present invention.

FIG. 9a is a sectional view of a preferred embodiment of the present invention.

FIG. 9b is a sectional view of an alternate embodiment of the present invention.

### DETAILED DESCRIPTION OF THE INVENTION

### A. Preferred Embodiment

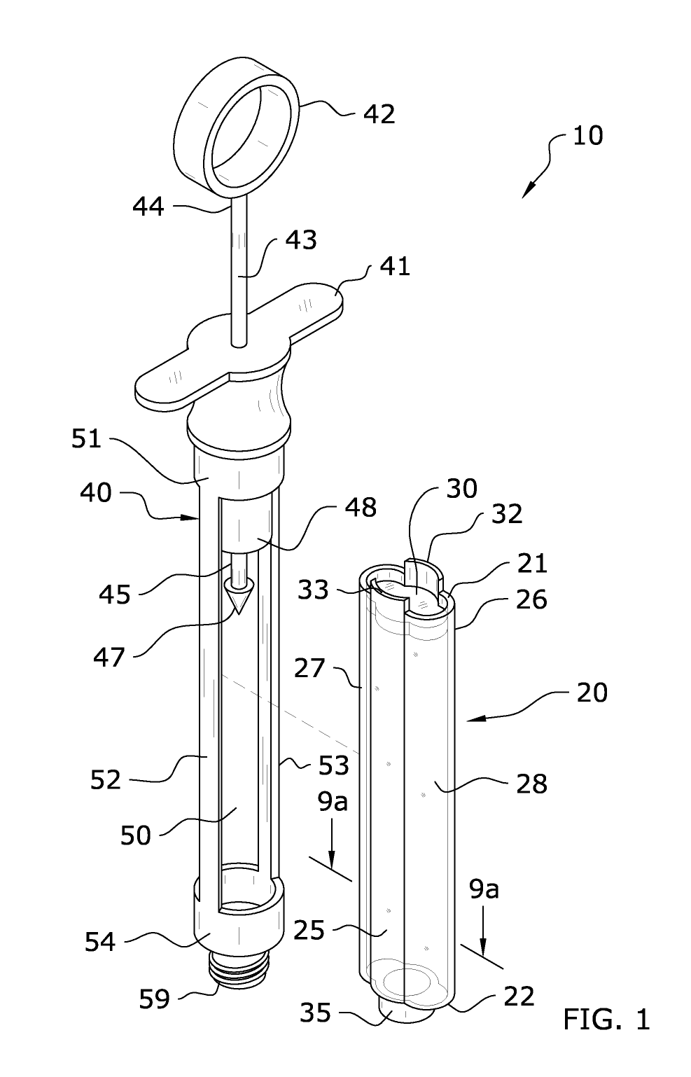

Turning now descriptively to the drawings, in which similar reference characters denote similar elements throughout the several views, FIGS. 1 through 4 illustrate a preferred embodiment of a high volume carpule system 10. The preferred embodiment of the present invention utilizes a high capacity carpule 20 and a syringe 40. The syringe 40 utilizes a modified carpule cavity 50 in the form of a frame comprised of an upper ring member 51, lower ring member 54, first side member 52 and second side member 53. The carpule 20 includes a rounded first side portion 27 and second side portion 28, wherein the first and second side portions 27, 28 extend out the respective sides of the carpule cavity 50.

i. Syringe.

As shown in FIG. 1, the present invention utilizes a syringe 40 for delivering the anesthetic stored within the carpule 20. The syringe 40 is generally comprised of a design which has been modified when compared to conventional syringe 40 designs to accommodate the higher capacity carpules 20 of the present invention.

The syringe 40 of the preferred embodiment of the present invention generally includes a plunger 43 having a first end 44 and a second end 45. A plunger grip 42 is generally attached to the first end 44 of the plunger 43. The plunger grip 42 is generally comprised of a handle utilized to press down and retract the plunger 43 of the present invention when delivering anesthetic from the carpule 20. The plunger grip 42 may be comprised of various structures, but will preferably be comprised of a circular member adapted to receive the finger of an operator of the present invention as shown in the figures.

The plunger grip 42 will generally extend through a syringe grip 41. The syringe grip 41 is generally comprised of a connecting structure which connects the plunger 43 of the present invention with the carpule cavity 50 of the present invention. The syringe grip 41 will generally include radial extensions to be grasped by an operator of the present invention.

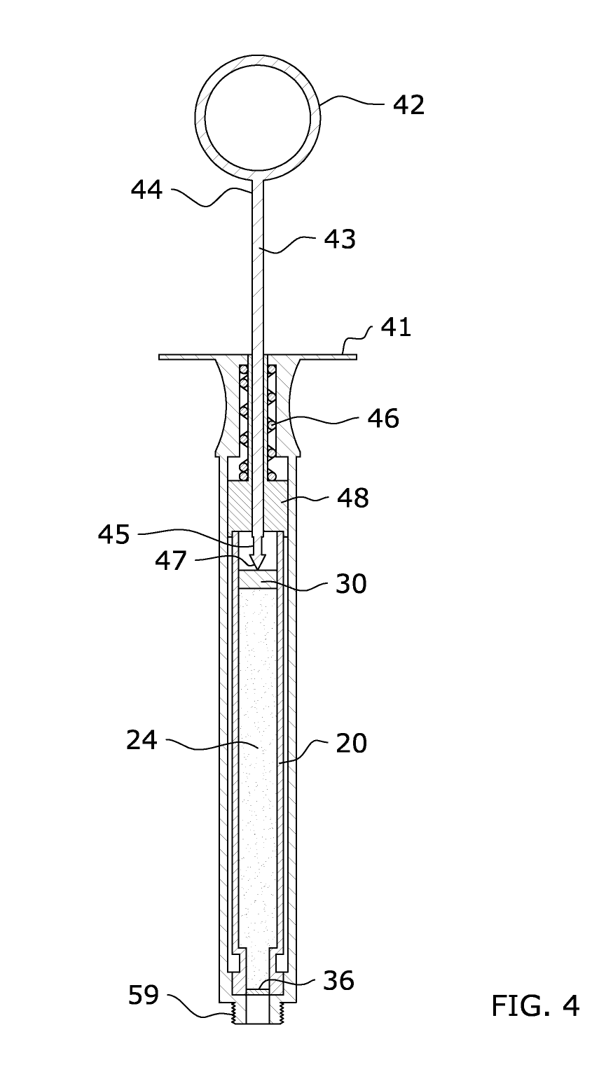

As shown in FIG. 4, the syringe grip 41 will generally include an opening extending therethrough through which the plunger 43 of the present invention extends. A bias member 46 generally surrounds the plunger 43 within the body of the syringe grip 41. A sleeve 48 will generally surround the plunger 43 below the bias member 46. The sleeve 48 will preferably act to compress the bias member 46 of the present invention when the plunger 43 is retracted for insertion of a carpule 20 within the carpule cavity 50. The bias member 46 of the present invention is preferably comprised of a circular spring surrounding the plunger 43 and the sleeve 48 will generally be comprised of a cylindrical member which is fixedly attached to the plunger 43 at a position below the bias member 46. The second end 45 of the plunger 43 generally includes a harpoon 47 or other pointed structure for engaging with the stopper member 30 of the carpule 20.

The second end 45 of the plunger 43 will generally extend into the carpule cavity 50 of the present invention. The carpule cavity 50 is generally comprised of a frame into which the carpule 20 of the present invention may be placed when the present invention is in use. The carpule cavity 50 is defined by an upper ring member 51 and a lower ring member 54, wherein a first side member 52 extends between a first position of the upper ring member 51 and a first position of the lower ring member 54 and a second side member 53 extends between a second position of the upper ring member 51 and a second position of the lower ring member 54. A first slot and second slot generally extend down the length of the carpule cavity 50, each slot being defined by the first and second side members 52, 53.

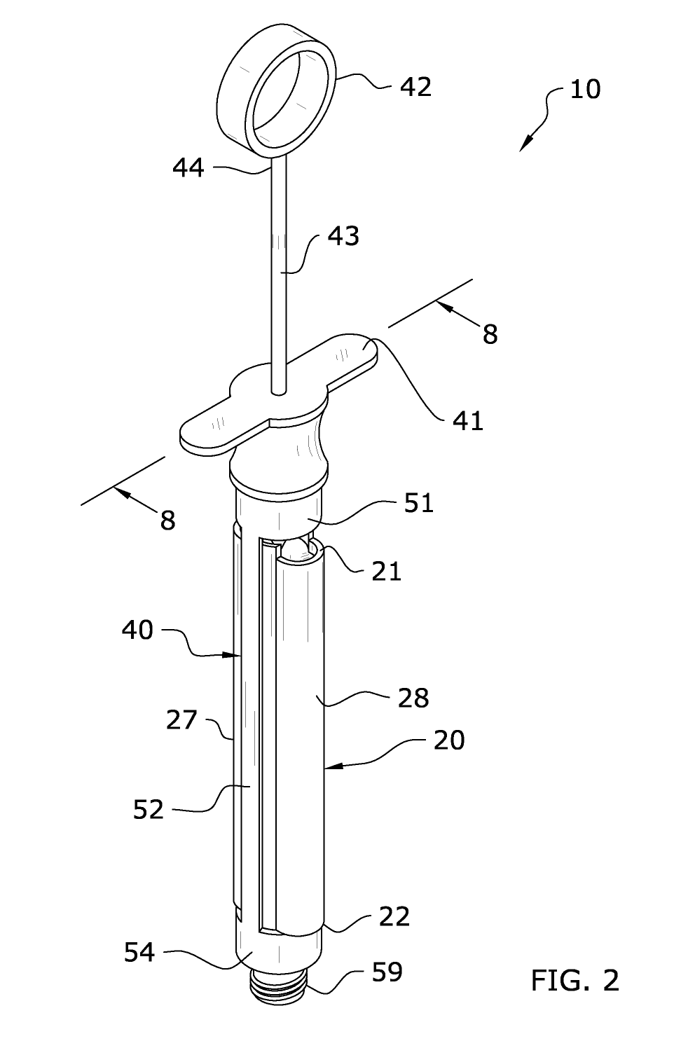

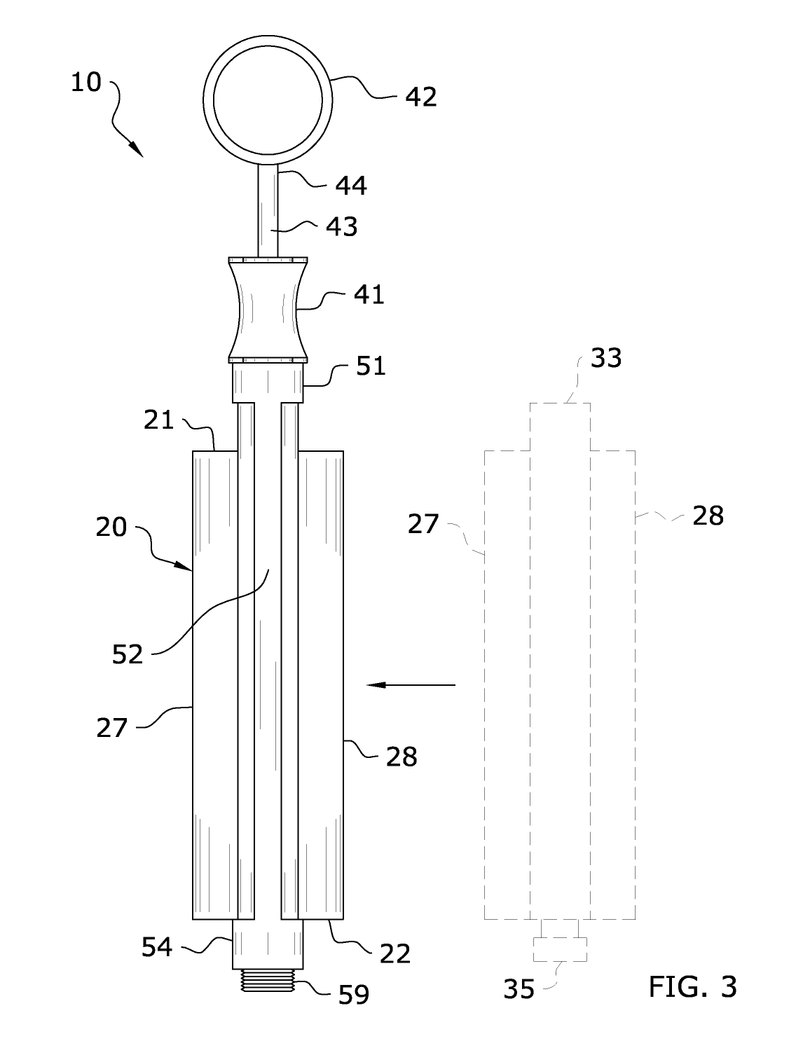

As shown in FIG. 2, the first position and second position will preferably be comprised of opposite sides of the respective ring members 51, 54 such that the first side member 52 retains and abuts against the front portion 25 of the carpule 20 and the second side member 53 retains and abuts against the rear portion 26 of the carpule 20. Because of the arrangement of the side members 52, 54 and the slots defined thereby, the first side portion 27 and second side portion 28 of the carpule 20 will be able to fit within the syringe 40 and extend out either slot of the carpule cavity 50 as shown in FIG. 3.

The syringe 40 will also generally include a lower opening 58 and a threaded connector 59. The lower opening 58 will generally act as a passageway through which anesthetic will be dispensed from the carpule 20 when the present invention is in use. The threaded connector 59 will be fluidly connected to the lower opening 58. A needle such as a hypodermic needle may be threadably attached to the threaded connector 59 when the present invention is in use.

ii. Carpule.

FIG. 1 illustrates a high capacity carpule 20 designed for use with the modified syringe 40 design. The carpule 20 of the present invention acts as a storage device for a volume of anesthetic or other substance to be used in a surgical setting. Preferably, the carpule 20 will be transparent or substantially transparent such that its contents may be viewed. The carpule 20 has been modified from existing designs, which have generally limited the volume of anesthetic capable of being stored within the prior art to approximately 1.7-1.8 milliliters.

The carpule 20 of the present invention will generally include a first end 21, a second end 22, a front portion 25, a rear portion 26, a first side portion 27 and a second side portion 28 as shown in FIG. 1. A chamber 24 will be defined between the ends 21, 22 and portions 25, 26, 27, 28 of the carpule 20. The chamber 24 will act as the storage device for the anesthetic within the carpule 20. The anesthetic itself will generally be viewable due to the transparent nature of the carpule 20. The carpule 20 of the present invention will preferably include a chamber 24 of sufficient size to store a volume of anesthetic which exceeds the 1.7-1.8 milliliter limitation of the prior art. In a preferred embodiment, the carpule 20 of the present invention will be adapted to store at least 3.5 milliliters of anesthetic.

The carpule 20 of the present invention will generally be comprised of a substantially cylindrical shape with an elongated cross-section as shown in the figures. The cylindrical shape of the carpule 20 will generally be formed by use of rounded side portions 27, 28 which extend outward from elongated front and rear portions 25, 26 as is best shown in FIG. 1. The front and rear portions 25, 26 of the carpule 20 will generally be comprised of portions which extend outwardly with a curved cross-sectional area. The side portions 27, 28 will each generally be comprised of portions with a semi-circular cross-section which extend from either side of the front and rear portions 25, 26.

The first side portion 27 and second side portion 28 will each generally have rounded outer surfaces and a substantially semi-circular cross-section. However, it is appreciated that various other shapes may be utilized for the carpule 20 so long as the carpule 20 is capable of storing higher volumes of anesthetic while being secured within the carpule cavity 50 of the modified syringe 40 design. Preferably, portions of the carpule 20 will extend out the sides of the carpule cavity 50 so as to allow higher volume capacities.

The front portion 25 and rear portion 26 will each generally be comprised of elongated members having a substantially curved surface. The front and rear portions 25, 26 are preferably parallel with the cross-sectional longitudinal axis of the carpule 20. A first radial end of the first side portion 27 will generally be connected to a first side of the front portion 25 while a second radial end of the first side portion 27 will generally be connected to a first side of the rear portion 26. A first radial end of the second side portion 28 will generally be connected to a second side of the front portion 25 while a second radial end of the second side portion 28 will generally be connected to a second side of the rear portion 26. In preferred embodiments, the front portion 25, rear portion 26, first side portion 27 and second side portion 28 will all be integrally formed to create a single carpule 20 which is of a substantially cylindrical shape with an elongated cross-section for use with the present invention.

The first end 21 of the carpule 20 will generally include a stopper member 30, a first tab 32 and a second tab 33. The stopper member 30 will generally be comprised of a structure which is slidably positioned within the carpule 20 to cover the first end 21 of the chamber 24 of the carpule 20. The stopper member 30 may be comprised of various materials, including plastics, rubber, silicone or combinations thereof

As shown in FIG. 4, the harpoon 47 of the syringe 40 will generally partially pierce and become attached to the stopper member 30 when the present invention is in use, so that pulling up on the plunger 43 will act to pull up the stopper member 30 and pushing down on the plunger 43 will act to push down the stopper member 30, thus dispensing the anesthetic being stored within the carpule 20. Pulling up on the plunger 43 will also generally create a vacuum within the carpule 20 itself, causing blood to enter the carpule 20 if the syringe 40 is properly inserted. This functionality may be utilized by an operator of the present invention to ensure proper insertion of the syringe 40 within a patient by viewing the carpule 20 to determine if blood is present upon drawing back the plunger 43.

The first and second tabs 32, 33 of the carpule 20 are used to secure the carpule 20 within the carpule cavity 50 of the syringe 40. When the carpule 20 is positioned within the cavity 50, the tabs 32, 33 will generally extend into the upper ring member 51 and engage therewith to secure the carpule 20 within the cavity 50. Preferably, the tabs 32, 33 will have substantially rounded outer surfaces to match the rounded inner surface of the upper ring member 51. However, it is appreciated that other configurations may be utilized so long as the tabs 32, 33 act to secure the carpule 20 within the cavity 50. Further, it is appreciated that more or less tabs 32, 33 may be utilized in various embodiments of the present invention.

The second end 22 of the carpule 20 will generally include a cap 35 and membrane 36 as best shown in FIG. 4. The membrane 36 will generally be comprised of a rubber-type substance through which a needle may be easily inserted and extracted for transfer of the anesthetic within the carpule 20. However, it is appreciated that, in some embodiments, a cap 35 and membrane 36 may be unnecessary. In such embodiments, the second end 22 of the carpule 20 may be comprised of a material which allows piercing by a needle without the need for a separate membrane 36 or cap 35. Further, it is appreciated that, in some embodiments, the carpule 20 may be comprised of a singular material which would allow such piercing access.

iii. Operation of Preferred Embodiment.

In use, a dentist or oral surgeon will generally administer anesthetic using a syringe 40 outfitted with a carpule 20. First, the plunger 43 of the syringe 40 is retracted against the bias member 46 so as to open up the cavity 50 for insertion of the carpule 20. The first end 21 of the carpule 20 is inserted into the upper ring member 51 of the carpule cavity 50 such that the tabs 32, 33 of the carpule 20 engage with the inner surface of the upper ring member 51. The second end 22 of the carpule 20 may then be inserted into the cavity 50. The plunger 43 is then released. Spring action from the bias member 46 will act to push the plunger 43 down until the harpoon 47 engages with the stopper member 30 of the carpule 20. In doing so, the second end 22 of the carpule 20 will be snugly positioned within the lower ring member 54.

The harpoon 47 will engage with the stopper member 30 in such a manner so as to allow action of the plunger 43 to directly push forward or draw back the stopper member 30. A hypodermic needle may then be attached to the threaded connector 59 of the syringe 40. An extension of the needle will generally extend through the lower opening 58 of the carpule cavity 50 and pierce the membrane 36 of the carpule 20 so as to create free passage for anesthesia to be delivered from the carpule 20 to the hypodermic needle upon downward action of the plunger 43. When use of the present invention is completed, the plunger 43 may be drawn back to compress the bias member 46 and allow the carpule 20 to be removed from the carpule cavity 50.

### B. Alternate Embodiment

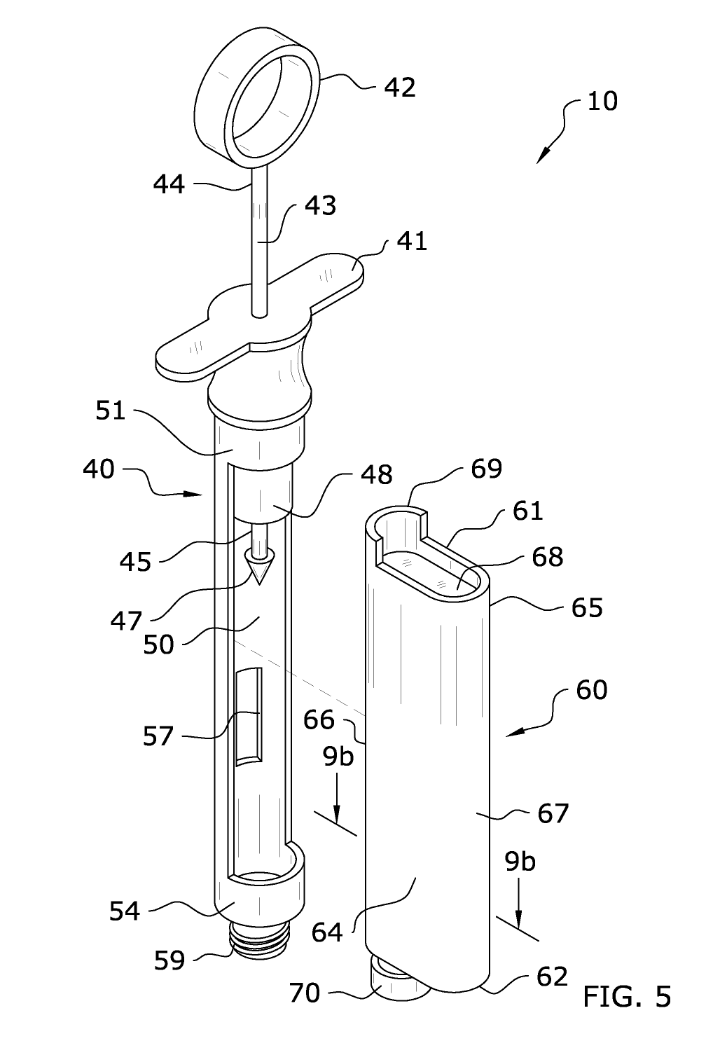

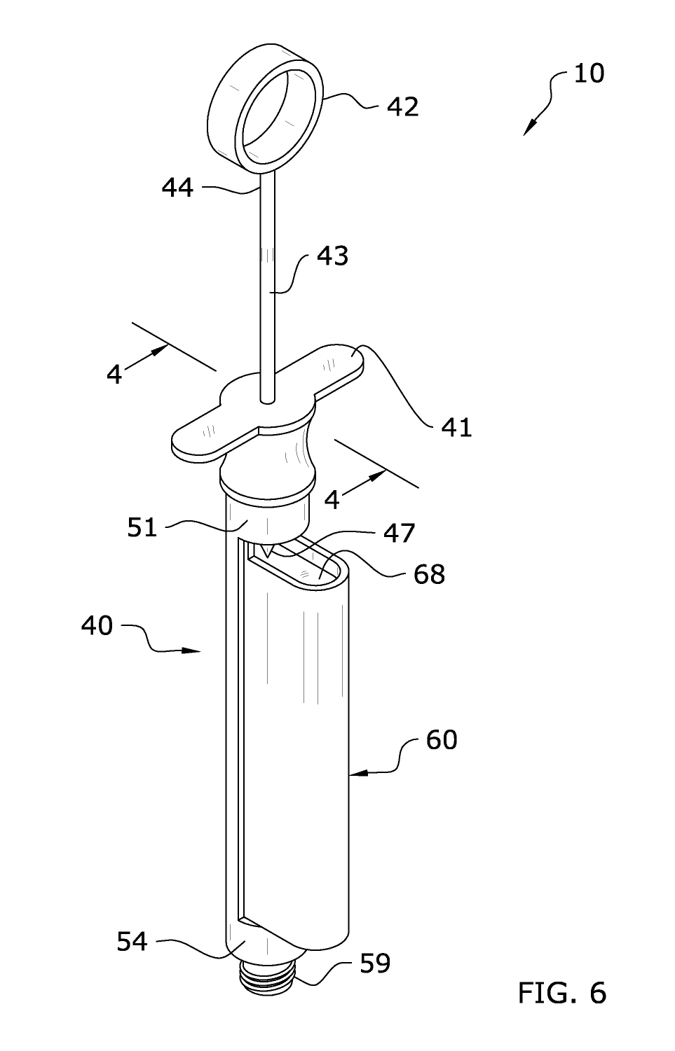

FIGS. 5-8 illustrate an alternate embodiment of the high volume carpule system 10. While the preferred embodiment of the present invention utilizes a modified syringe 40 design, the alternate embodiment may be utilized with conventional prior art syringes 40. As shown in FIG. 5, the conventional syringe 40 will generally include a back wall 56 covering a portion of its carpule cavity 50. A carpule slot 57 is positioned on the back wall 56 which is generally utilized by the operator to view the contents of the carpule 60 to confirm whether the needle of the syringe 40 is properly positioned in a blood vessel.

The alternate embodiment of the present invention utilizes a new, high capacity carpule 60 design adapted to be utilized with existing, conventional syringes 40. The carpule 60 will generally include a first end 61, a second end 62, a front portion 64, a rear portion 65, a first side portion 66 and a second side portion 67 which, together, form the container and dispenser for anesthetic to be delivered by the syringe 40.

A chamber 63 will be defined by the ends 61, 62 and portions 64, 65, 66, 67 of the carpule 60. The chamber 63 will act as the storage device for the anesthetic within the carpule 60. The carpule 60 of the present invention will preferably include a cavity 64 of sufficient size to store a volume of anesthetic which exceeds the 1.7-1.8 milliliter limitation of the prior art. In a preferred embodiment, the carpule 60 of the present invention will be adapted to store at least 3.5 milliliters of anesthetic.

The carpule 60 of the present invention will generally be comprised of a cylindrical shape having an elongated cross-section as shown in FIGS. 5-8. The front and rear portions 64, 65 will preferably be comprised of a substantially flat, elongated surface. The first and second side surfaces 66, 67 will preferably be comprised of curved surfaces which bridge the front and rear portions 64, 65 to form a completed carpule 60 structure.

The first end 61 of the carpule 60 will generally include a tab 69 extending upwardly from the first side surface 66. The tab 69 may be comprised of various structures, but will preferably be comprised of a semi-circular extension which extends upwardly from the first end 61 of the first side surface 66 of the carpule 60. The tab 69 will generally be positioned and secured within the upper ring member 51 of the carpule cavity 50 when the present invention is in use.

The first end 61 of the carpule 60 will also generally include a stopper member 68. The stopper member 68 will generally be comprised of a structure which is slidably positioned within the carpule 60 to cover the first end 61 of the chamber 63 of the carpule 60. The stopper member 68 may be comprised of various materials, including plastics, rubber, silicone or combinations thereof

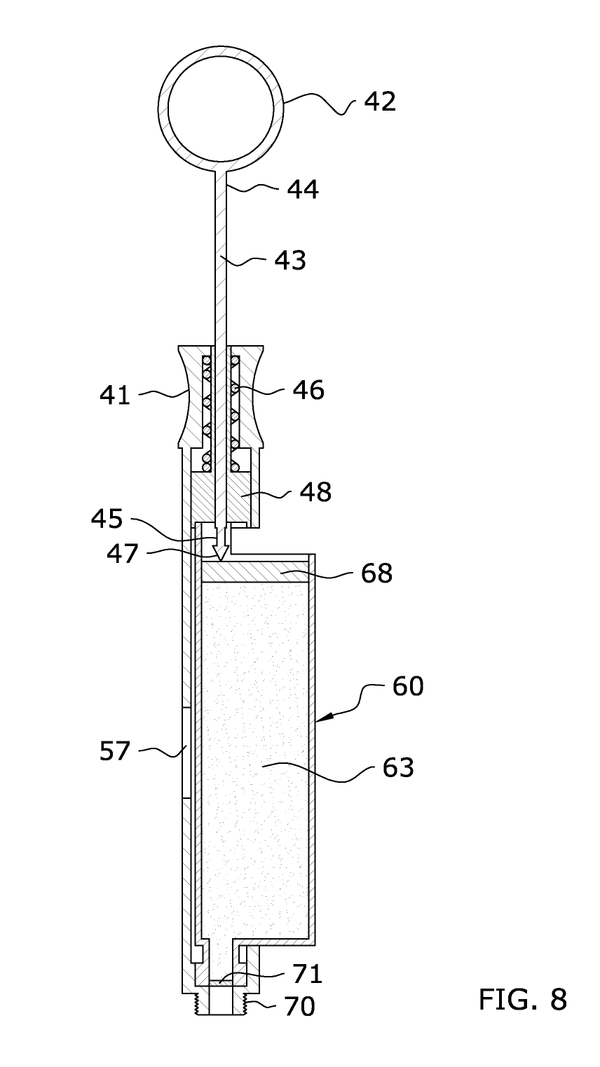

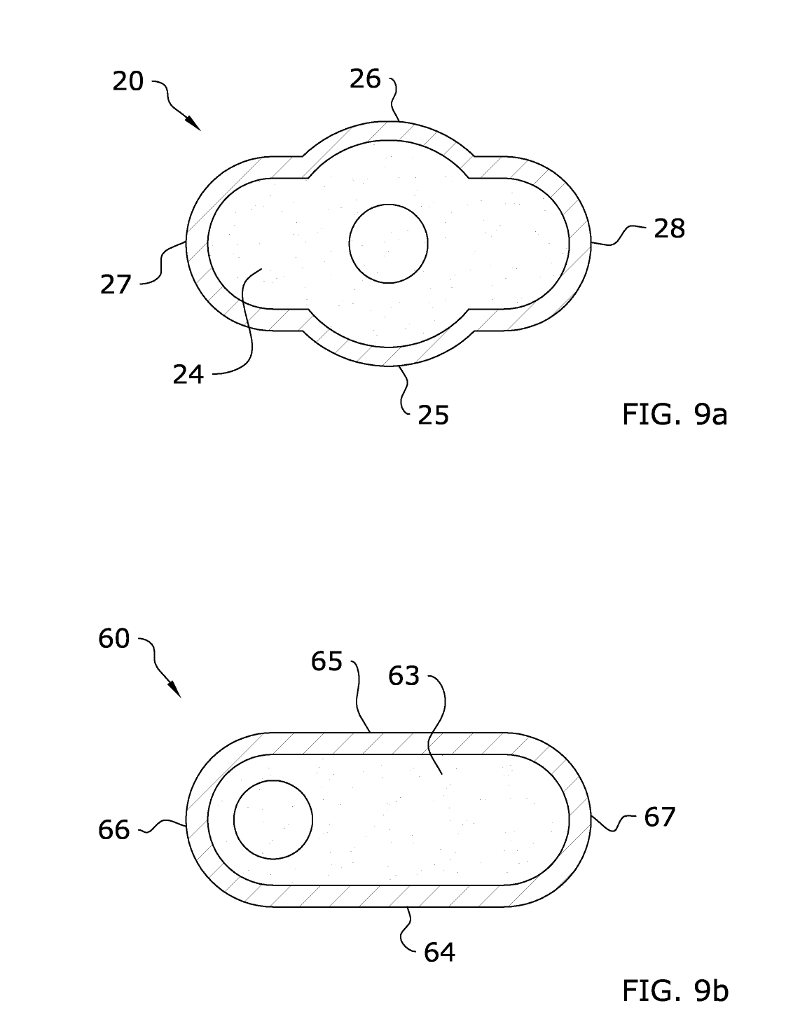

As shown in FIG. 8, the harpoon 47 of the syringe 40 will generally partially pierce and become attached to the stopper member 68 when the present invention is in use such that pulling up on the plunger 43 will act to pull up the stopper member 68 and pushing down on the plunger 43 will act to push down the stopper member 68, thus dispensing the anesthetic stored within the carpule 60. Pulling up on the plunger 43 will also generally create a vacuum within the carpule 60 itself, causing blood to enter the carpule 60 if the syringe 40 is properly inserted. This functionality may be utilized by an operator of the present invention to ensure proper insertion of the syringe 40 within a patient by viewing the carpule 60 to determine if blood is present upon drawing back the plunger 43.

The second end 62 of the carpule 60 will generally include a cap 70 and membrane 71 as best shown in FIG. 8. The membrane 71 will generally be comprised of a rubber-type substance through which a needle may be easily inserted and extracted for transfer of the anesthetic within the carpule 60. However, it is appreciated that, in some embodiments, a cap 70 and membrane 71 may be unnecessary. In such embodiments, the second end 62 of the carpule 60 may be comprised of a material which allows piercing by a needle without the need for a separate membrane 71 or cap 70. Further, it is appreciated that, in some embodiments, the carpule 60 may be comprised of a singular material which would allow such piercing access.

In use, a dentist or oral surgeon will generally administer anesthetic using a syringe 40 outfitted with a carpule 60. First, the plunger 43 of the syringe 40 is retracted against the bias member 46 so as to open up the cavity 50 for insertion of the carpule 60. Instead of inserting a limited capacity carpule through the carpule slot 57 on the back wall 56 of the carpule cavity 50 as has previously been done, the first end 61 of the carpule 60 is inserted into the upper ring member 51 of the carpule cavity 50 such that the tabs 69 of the carpule 60 engages with the inner surface of the upper ring member 51. The second end 62 of the carpule 60 may then be inserted into the cavity 50. However, it is appreciated that the order in which the ends 61, 62 are inserted may be reversed.

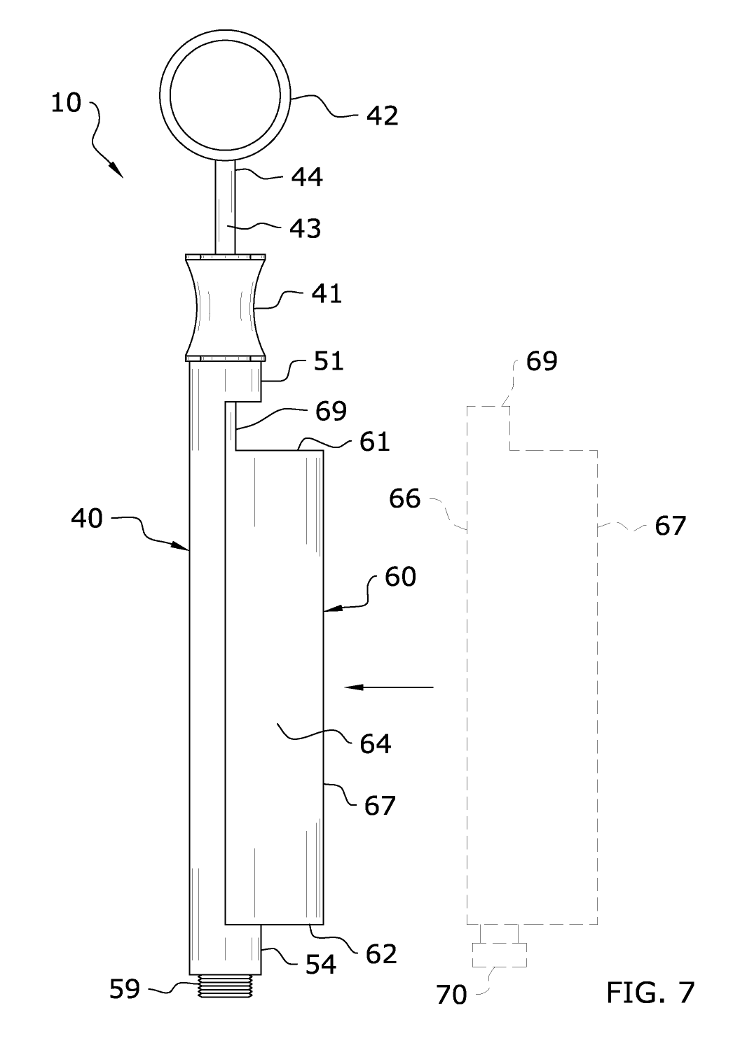

The first side portion 66 of the carpule 60 will abut against the back wall 56 of the syringe 40 and the second side portion 67 of the carpule 60 will extend outwardly from the syringe 40 as shown in FIG. 7. The plunger 43 is then released. Spring action from the bias member 46 will act to push the plunger 43 down until the harpoon 47 engages with the stopper member 68 of the carpule 60. In doing so, the second end 62 of the carpule 60 will be snugly positioned within the lower ring member 54.

The harpoon 47 will engage with the stopper member 68 in such a manner so as to allow action of the plunger 43 to directly push forward or draw back the stopper member 68. A hypodermic needle may then be attached to the threaded connector 59 of the syringe 40. An extension of the needle will generally extend through the lower opening 58 of the carpule cavity 50 and pierce the membrane 71 of the carpule 60 so as to create free passage for anesthesia to be delivered from the carpule 60 to the hypodermic needle upon downward action of the plunger 43. When use of the present invention is completed, the plunger 43 may be drawn back to compress the bias member 46 and allow the carpule 60 to be removed from the carpule cavity 50.

Unless otherwise defined, all technical and scientific terms used herein have the same meaning as commonly understood by one of ordinary skill in the art to which this invention belongs. Although methods and materials similar to or equivalent to those described herein can be used in the practice or testing of the present invention, suitable methods and materials are described above. The present invention may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

The invention claimed is:

1. A high volume carpule system, comprising:
a syringe for dispensing an anesthetic;
a carpule cavity within said syringe for securing a carpule, wherein said carpule cavity includes a first slot and a second slot; and
a carpule for storing an anesthetic, wherein said carpule includes a first side portion and a second side portion, wherein said first side portion extends through said first slot and said second side portion extends through said second slot.

2. The high volume carpule system of claim 1, wherein said carpule is comprised of a cylinder with an elongated cross-section.

3. The high volume carpule system of claim 1, wherein syringe includes an upper ring member and a lower ring member.

4. The high volume carpule system of claim 3, wherein said syringe includes a first side member extending from said upper ring member to said lower ring member and a second side member extending from said upper ring member to said lower ring member.

5. The high volume carpule system of claim 4, wherein said first slot is positioned between a first side of said first side member and a first side of said second side member.

6. The high volume carpule system of claim 5, wherein said second slot is positioned between a second side of said first side member and a second side of said second side member.

7. The high volume carpule system of claim 1, wherein said first side portion of said carpule is comprised of a semi-circular cross-section.

8. The high volume carpule system of claim 7, wherein said second side portion of said carpule is comprised of a semi-circular cross-section.

9. The high volume carpule system of claim 1, wherein said carpule includes a chamber capable of storing more than three milliliters of anesthetic.

10. The high volume carpule system of claim 1, wherein said carpule includes a first tab and a second tab.

11. The high volume carpule system of claim 10, wherein said first tab and said second tab are positionable within said upper ring member.

12. The high volume carpule system of claim 1, wherein said carpule includes a cap and membrane.

13. The high volume carpule system of claim 1, wherein said carpule includes a stopper member.

14. A high volume carpule system comprising:
a syringe for dispensing an anesthetic;
a carpule cavity within said syringe for securing a carpule, wherein said carpule cavity includes a back wall, wherein said carpule cavity includes an upper ring member; and
a carpule for storing an anesthetic, wherein said carpule includes a first side portion and a second side portion, wherein said first side portion abuts against said back wall, wherein said carpule is comprised of a cylinder with an elongated cross-section

15. The high volume carpule system of claim 14, wherein said carpule includes a tab, wherein said tab is positionable within said upper ring member.

16. The high volume carpule system of claim 14, wherein said carpule includes a chamber capable of storing more than three milliliters of anesthetic.

17. The high volume carpule system of claim 14, wherein said tab extends upwardly from said first side portion of said carpule.

18. The high volume carpule system of claim 14, wherein said carpule includes a stopper member.

19. A high volume carpule system, comprising:
a syringe for dispensing an anesthetic, wherein said syringe includes an upper ring member and a lower ring member, wherein said syringe includes a first side member extending from said upper ring member to said lower ring member and a second side member extending from said upper ring member to said lower ring member;
a carpule cavity within said syringe for securing a carpule, wherein said carpule cavity includes a first slot and a second slot, wherein said first slot is positioned between a first side of said first side member and a first side of said second side member, wherein said second slot is positioned between a second side of said first side member and a second side of said second side member;
a carpule for storing an anesthetic, wherein said carpule includes a first side portion and a second side portion, wherein said first side portion extends through said first slot and said second side portion extends through said second slot, wherein said carpule is comprised of an cylinder shape having an elongated cross-section, wherein said first side portion of said carpule is comprised of a semi-circular cross-section, wherein said second side portion of said carpule is comprised of a semi-circular cross-section, wherein said carpule includes a cap and a membrane, wherein said carpule includes a stopper member;
a first tab extending upwardly from said first side portion of said carpule; and
a second tab extending upwardly from said second side portion of said carpule, wherein said first tab and said second tab are positionable within said upper ring member.

20. The high volume carpule system of claim 19, wherein said carpule includes a chamber capable of storing more than three milliliters of anesthetic.
